(19) United States
(12) Patent Application Publication
(10) Pub. No.: US 2017/0071161 A1
(43) Pub. Date: Mar. 16, 2017

(54) Method for Training Animals

(71) Applicant: Jerry D. Barnes, JR., Hartville, OH (US)

(72) Inventor: Jerry D. Barnes, JR., Hartville, OH (US)

(21) Appl. No.: 14/855,594

(22) Filed: Sep. 16, 2015

(51) Int. Cl. A01K 27/00; A01K 29/00

(52) U.S. Cl. CPC A01K 27/003; A01K 29/005

(57) ABSTRACT

A method for training animals of various types, and particularly dogs, is presented. The method of the invention focuses upon training steps including the development of long-line attention, stair exercise, walking and control, and short-work exercises that can be undertaken within a home or confined area. Each of the steps serves as a building block for the next.

### TECHNICAL FIELD

The invention herein resides in the art of training animals and, more particularly, for training canines or dogs. Specifically, the invention relates to a methodology for training dogs that relies on the development of a relationship between the dog and its handler, while compliance by the dog is rewarded without concessions or placating by the handler.

### BACKGROUND ART

It is presently estimated that 70-80 million dogs and 74-96 million cats are owned by households in the United States. Upwards of 47% of all households in the United States have a dog and 30-37% have a cat. Most dog owners take the greatest pleasure in their pet when the dog is obedient and responsive. In many families, a dog is a near-human member, being a playmate for children while the family is growing and replacing the children as a companion when the children are raised.

Dogs are found to be most enjoyable when they are disciplined. When a dog is responsive to its master's commands, both reap the benefits. However, dogs are not automatically obedient or disciplined. Rather, their inherent intelligence and demeanor must be molded and fashioned in such a manner that the dog finds fulfillment in pleasing its master, and responsiveness to its master's will is substantially automatic or, at least, second nature.

Various methodologies have been employed in the past for training dogs. Work dogs, such as those used in law enforcement, service dogs for the blind and disabled, sporting dogs used in hunting, and farm dogs used for herding all require specialized training, even though dogs selected for such work are typically of a breed having a propensity for performing it.

The invention herein is particularly applicable to dogs that are simply owned as pets or for companionship. A dog trained to comply with certain simple rules of obedience and discipline enhances the dog-master relationship. The prior art has been devoid of a technique or methodology for effectively training dogs in basic discipline processes. The prior art has been devoid of teaching core values of training that are necessary in achieving long-lasting benefits.

While professional training of service or work dogs and the peculiarities incident thereto may be left to specialized training, there remains an overriding need for an efficient and effective means for training dogs that serve merely as pets or companions to be obedient and responsive to the commands and needs of the owner.

### SUMMARY OF THE INVENTION

In light of the foregoing, it is an aspect of the invention to provide a method for training animals, and particularly dogs, that is efficient and effective.

Another aspect of the invention is the provision of a method for training animals, and particularly dogs, that takes a positive approach toward training, rather than one of correction and punishment.

Still a further aspect of the invention is the provision of a method for training animals, and particularly dogs, that addresses at least four basic interrelationship activities between a dog and its owner.

Still a further aspect of the invention is the provision of a method for training animals, and particularly dogs, that engenders a close bond between the dog and its owner while ensuring that the dog is well behaved, obedient, and submissive to the will of the owner.

The foregoing and other aspects of the invention that will become apparent as the detailed description proceeds are achieved by a method for training a dog, comprising: developing distance attention in the dog with a long-line leash, effecting a return of the dog to the trainer upon the trainer issuing a command to “come;” developing restraint in the dog in effectively negotiating stairs without forging ahead of the trainer; developing discipline in the dog to walk alongside the trainer on an over-the-shoulder leash and within a zone established by the leash; and undertaking behavioral training of the dog with leash and collar constraint within a home environment and during daily routines.

### DESCRIPTION OF DRAWINGS

For a complete understanding of the various aspects and techniques of the invention, reference should be had to the following detailed description and accompanying drawings, wherein:

FIG. 1 is an illustrative view of a dog in training alongside its trainer as the trainer begins to walk;

FIG. 2 is an illustrative view of a dog in training as shown in FIG. 1, showing the engagement of the trainer's thigh with the dog's leash, causing the dog to move forward;

FIG. 3 is an illustrative view front view of a dog and its trainer in which the dog's collar is secured to an over-the-shoulder leash worn by the trainer;

FIG. 4 is an illustrative side view of the dog and trainer as shown in FIG. 3;

FIG. 5 is an illustrative view of the hand position of the trainer on the dog's leash when commencing a “sit” command; and

FIG. 6 is an illustrative view in the sequence of FIG. 5, showing the positioning of the trainer's hand to effect the “sit.”

### DETAILED DESCRIPTION OF PREFERRED EMBODIMENTS

Observations have shown that nearly two-thirds of dogs that are owned as pets have discipline problems or deficiencies. The most common is apparent when a dog is placed on a leash to be taken for a walk. Typically, the dog pulls against the collar to which the leash is attached, causing the leash to be maintained in taut orientation during substantially the entire duration of the walk. Absent discipline in the dog itself, this is a natural tendency of dogs and is rarely eliminated by the use of collars and leashes of various designs, orientations, and configurations. Indeed, the observation of most dog owners who put their dog on a leash causes one to question who is in control. In contradistinction to what is normally encountered, most dog owners wish for the dog to willingly and attentively walk beside the owner with the leash remaining slack. The method of the invention contemplates a four-step process by which a dog may be trained in various aspects of its interrelationship with its owner, resulting in a dog that is obedient and disciplined in the areas of basic interrelationships between a dog and its owner.

According to a preferred embodiment of the invention, the training can occur in a kennel where dogs are temporarily housed. The training begins with a session of acquaintance and interengagement with the dog and extends over a period of 48-72 hours. It has generally been found that as little as a 24-hour period is sufficient to achieve desired results. The trainer begins by observing the dog's general behavior in the new environment and particularly with other dogs being kenneled. During that period, the dog socializes with other dogs and with people at the kennel. Next, the trainer selects an appropriately sized, over-the-shoulder design leash, collar, or walking harness to be used in the training. Using an over-the-shoulder design leash promotes relaxation to the handler and provides a hands-free way to walk the dog. The collar/harness selection is based upon an observation of the current overall behavior of the dog to be trained and the current capabilities/experience of the owner/handler. During the training period, at least three separate training sessions are engaged, each including a 1-2 mile walk.

There are certain core values that must necessarily be apparent throughout the training sessions of the dog. A first core value is to reinforce attentiveness, willingness, and complicit behavior from the dog, which is fundamental to a good relationship between the dog and its master. Throughout the sessions, the dog must be handled calmly and confidently with an expectation of success in the mind of the trainer. The dog must be rewarded when the desired behavior is achieved. The dog should be praised quietly with touching/petting of the dog being the primary reinforcement for the dog correctly performing the desired behavior and before any other reinforcement is engaged. Throughout training, a minimum amount of pressure or correction should be used to influence the dog's behavior. Rather, the dog should be sincerely and genuinely praised for engaging in the desired behavior. Of specific importance is the fact that there must be consistence of command for the desired behavior. Finally, and significantly, is the fact that the trainer should not placate the dog, but should remain the master, although a benevolent one. It should not be the goal of the master or trainer to appease or pacify the dog, nor to make concessions or conciliatory gestures to the dog. Rather, the dog should understand the reasonable expectations of the master.

As a first step in the training sequence, the distance or long-line attention of the dog is developed. Here, with an appropriate collar or harness in place, a long-line leash of approximately 25-30 feet in length is attached to the collar. The trainer remains quiet, holding the leash loosely so that the dog feels no tension and is free to wander away, as most dogs are wont to do. As the dog is naturally distracted, the trainer puts as much distance as possible between the trainer and the dog. The slack in the leash should be maintained at a minimum without alerting the dog by a pulling sensation. With the dog and the trainer separated by as much distance as possible without alerting the dog and with the leash in a static hand of the trainer, the trainer states the dog's name and commands the dog to “come.” Immediately, the trainer applies only the force necessary on the leash to turn the dog, and then the trainer gently pulls the leash through his static hand. The instant the dog either makes eye contact with the trainer or willingly takes a first step toward the trainer, the trainer offers verbal praise and encouragement, repeating the “come” command. This command can be repeated as long as the dog is complying since praise during the desired behavior actually reinforces the command. Depending upon the size of the dog and the speed at which the dog responds to the command, the trainer may find it necessary to trot backwards while retracting the leash as the dog closes ground upon him. Should the dog either break eye contact or veer off course, the trainer should immediately stop talking. The instant either activity resumes (eye contact or movement on course), the trainer renews the verbal praising and encouragement. As the dog comes all the way into the trainer, the trainer lifts his free hand up under the leash and issues a single “sit” command, with only enough pressure on the leash to effect compliance. As soon as the dog appears to willingly begin to relax into a sit position, the trainer resumes the praise and, while praising, softly and reassuringly pets the dog. The trainer then may give the dog a treat or other reinforcement, such as a ball or tug toy, based upon the dog's particular reinforcement preferences. During this phase, the trainer should be standing erect and positioning the reward (food or toy) on his/her side at a height relative to the dog's size between the dog's eyes and the trainer's eyes to achieve attentiveness toward the trainer. The reason the reinforcement is distributed on the handler's side is to build an enforcement placement history to the side the handler wishes to walk the dog. The drive that the dog has for the food, treat, or toy adds value to the training environment, the command that started reinforcement, and the tactile stimulation from the touch or petting.

As the dog becomes distracted and looks away from the trainer, the training process continues. As the trainer quietly picks up the leash and walks directly away from the dog, opposite from where the dog is looking. The process of “come” and “sit,” as discussed above, is then renewed for a number of sets, the dog having the time to drift away between sets, during which time the trainer reflects on observations of the dog's behavior and any improvements necessary (such as handler's timing and technique) to hone the next iteration.

As the “come-sit” command sequence is repeated, improved response from the dog and improved timing and performance of the trainer are a common result when attention is paid to the prior exercises. Anytime the trainer walks away from the dog and the dog is attentive and willing to follow the trainer, such behavior is praised and encouraged. When the dog commits to coming all the way up to the trainer, touching, petting, and praising of the dog is practiced. While praising and touching/petting the dog for desired behaviors or approximations thereof is desired, it is equally important that the trainer not offer unintentional encouragement when the behavior is not desired. At those times, the trainer needs to remain calm and quiet.

In practice, it has been found that for a well-adjusted dog, it takes only about five or six engagements of the “come-sit” exercise before the dog is paying close attention to the master/trainer and begins to follow the master/trainer satisfactorily. At that time, the dog and trainer can and should move to the next step of the training exercise.

It is a common tendency for dogs to have a natural urge to bolt through doorways, gates, or up a set of stairs ahead of the master. Typically, this type of activity is not desirable. Training on stairs is an effective way to check or control this type of compulsive behavior of the dog since gravity becomes an assistant in the exercise. As a rule, during this exercise the dog may be on the same step as the trainer or on the step behind the trainer, but never in front of the trainer. In the context of the invention, this appears to be one of the most important single exercises that can crystallize the dog-handler relationship and the criteria of the dog honoring the handler's leadership.

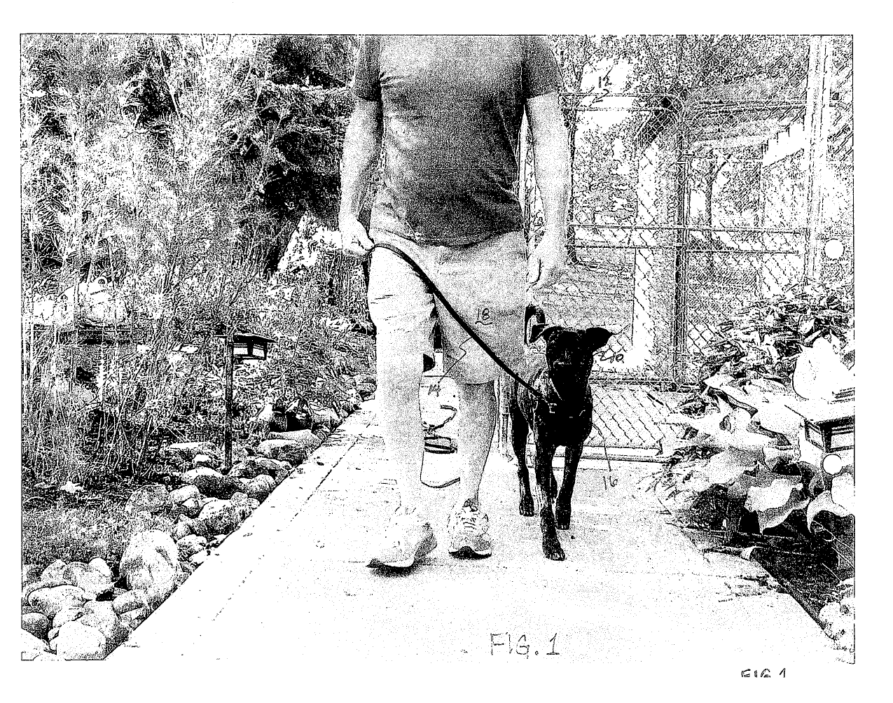

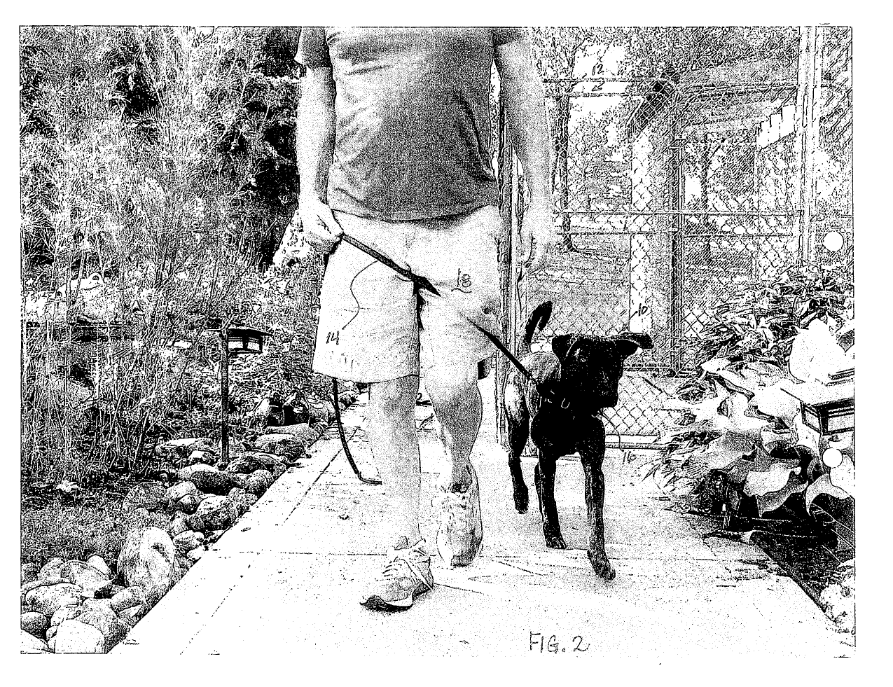

Preferably, this stair exercise is performed on a set of outdoor steps. The fundamental relationship between the dog 10 and its trainer 12 for this training exercise is shown in FIGS. 1 and 2. The trainer begins by standing about 10 feet away from the outside set of steps with the dog at the trainer's side (i.e., the left) and a long leash 14 in the trainer's opposite (i.e., the right) hand and attached to the dog's collar/harness 16. The trainer's left arm and hand must be relaxed and the arm hanging freely at his/her side. The leash is to be held loosely in the trainer's right hand. The length of the leash 14 from the handler's right hand to the collar 16 should be short enough so that when walking, the leash 14 crosses the trainer's left thigh 18 (above the knee and below the hip). This allows the left arm closest to the dog 10 to remain free, relaxed, and naturally swinging. In the sequence between FIGS. 1 and 2, it can be seen that if the dog is not attentive when the trainer begins to walk (FIG. 1), the trainer's left thigh 18 will feel the pressure of the leash as it initiates the movement of the dog (FIG. 2). The thigh is utilized because the thigh is the largest/strongest muscle in the body. Thus, movement of the dog by the trainer's thigh is a substantially effortless and automatic event. The intent is that the trainer is relaxed, confident, and looking forward. This places the power to move the dog forward without the trainer twisting or compromising his/her leadership topography. The trainer begins walking toward the steps. If the dog determines to forge ahead to run up the steps, the trainer allows it, paying out a few more feet of the leash, as necessary. When the dog is about five steps in front of the trainer, and without saying a word, the trainer closes his hand on the leash to terminate the payout of leash. At the same time, the trainer begins to back down the steps, which will cause the dog to either make eye contact with the trainer or display a willingness to retreat down the stairs on its own. In either event, the trainer immediately praises the dog. This exercise is repeated with the expectation that there will be less inclination of the dog to bolt up the stairs on each subsequent iteration of the exercise. Increased verbal praise and touching of the dog by the trainer reinforces the behavior of the dog such that the tendency of the dog to forge up the stairs diminishes, and its willingness to comply increases.

It has been found that after three or four of the foregoing stair exercises have been engaged, the dog will begin looking at the trainer frequently. At this point, when the trainer observes that the dog's attention is focusing on the step in front of the trainer, the trainer makes quick leash checks, which tend to urge the dog in the direction of the check.

When the dog moves to the step upon which the trainer is standing, immediate praise, touching, and even the offering of a treat is the immediate response. The trainer may then turn away from the dog and retreat down the steps, praising the dog for following. At this point, the stair exercise may be engaged for more iterations, reinforcing willing compliance. Upon recognizing that the behavior of staying on the step on which the trainer is standing results in praise, affection, and/or a treat, the dog's behavior will so conform.

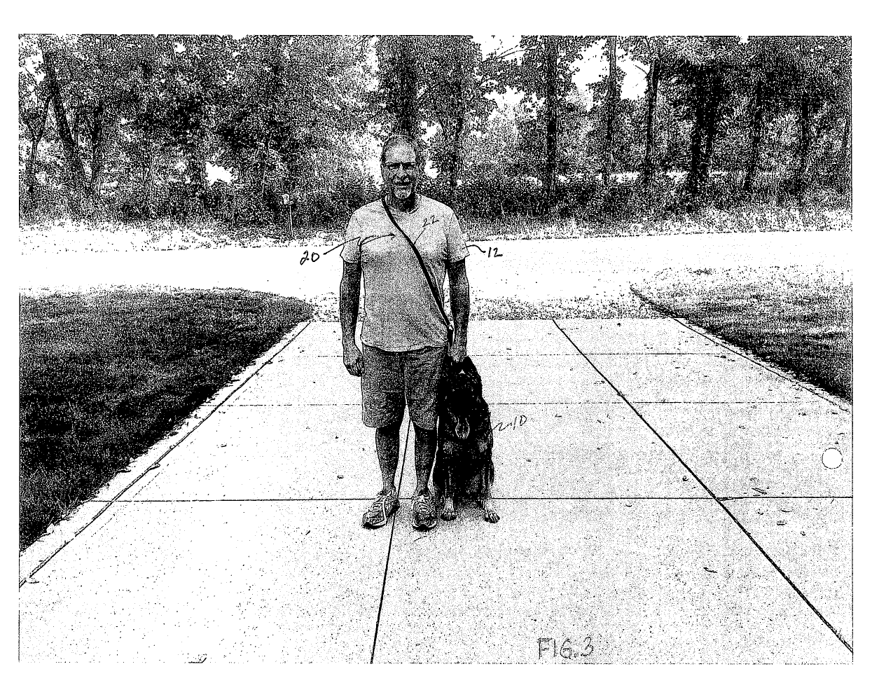

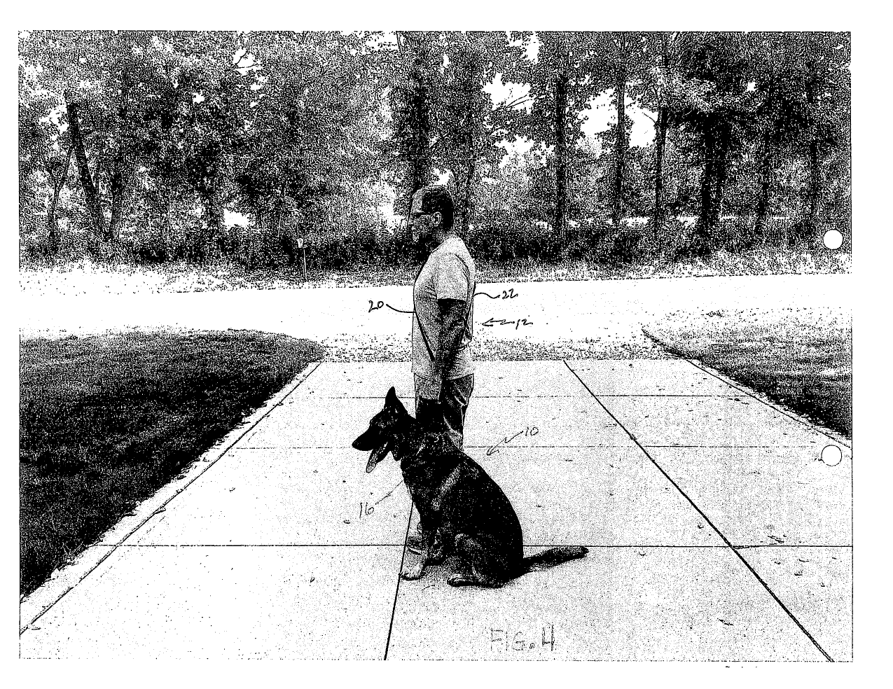

In the third step of the training process, the dog is taught how to walk with its master, alongside the master. Here, and as shown in FIGS. 3 and 4, an over-the-shoulder, hands-free style of leash 20 is required. As is well known, such a leash has a large loop 22 at the end opposite the dog 10. The trainer 12 places his arm and head through the loop 22 so that the loop rests on his shoulder on the opposite side of the trainer along which the dog 10 will walk. The leash extends on the side of the trainer to the collar 16 of the dog. The trainer begins walking at a fairly brisk pace, looking straight ahead with shoulders relaxed and arms swinging freely at the trainer's side. When the dog is in front of or behind the trainer, the trainer will feel the dog's presence through the leash. When the trainer does not feel the dog on the leash, that indicates that the dog is at the trainer's side, and the dog is then praised as the walk continues. During the walk, the trainer pays attention to the dog only by either praising and/or occasionally reaching down and touching the dog when the dog is within the “sweet zone,” where the trainer does not feel the dog on the leash at all. If the dog lags behind, the trainer will feel pressure from the tip of his shoulder down across his chest to his sternum. When that happens, the trainer stays quiet and immediately speeds up pace, forcing the dog to increase its pace as the leash pulls across the trainer's chest to the dog's collar. The instant the trainer feels the dog catching up (a transition phase), the trainer immediately begins praising the dog in a sincere and encouraging manner while continuing to look straight ahead and without breaking stride.

If the dog starts to forge ahead, the trainer needs to make a check on the leash to correct the dog. The instant the dog drops back into the “sweet zone” or reinforcement zone, the trainer must praise, touch, and even offer a treat to the dog.

If the dog has a tendency to walk ahead of the trainer, the trainer may start working the dog to one side or the other in a circle such that the dog must yield to the trainer's encroachment. When the dog yields to that encroachment, it is immediately praised. It is of extreme importance that the trainer does not yield to the dog or placate or compromise to the dog's position. Rather, the trainer must remain relaxed and move confidently, reinforcing attentiveness and willingness in the dog.

If the dog has a tendency to forge ahead, the trainer may, upon sensing such movement, reach down and grab the leash and apply just enough backward force to momentarily pause the dog's forward progress while smoothly and confidently performing a very tight 180-degree turn directly into the dog. The trainer may need to shuffle his feet so as not to step on the dog's paws. The object is to displace the dog. The instant the trainer sees the dog beginning to yield to the trainer, the trainer must praise the dog's willingness, but must keep walking and immediately get back into a normal pace. Noticing and acknowledging these types of transitions are vital to shaping the desired behavior.

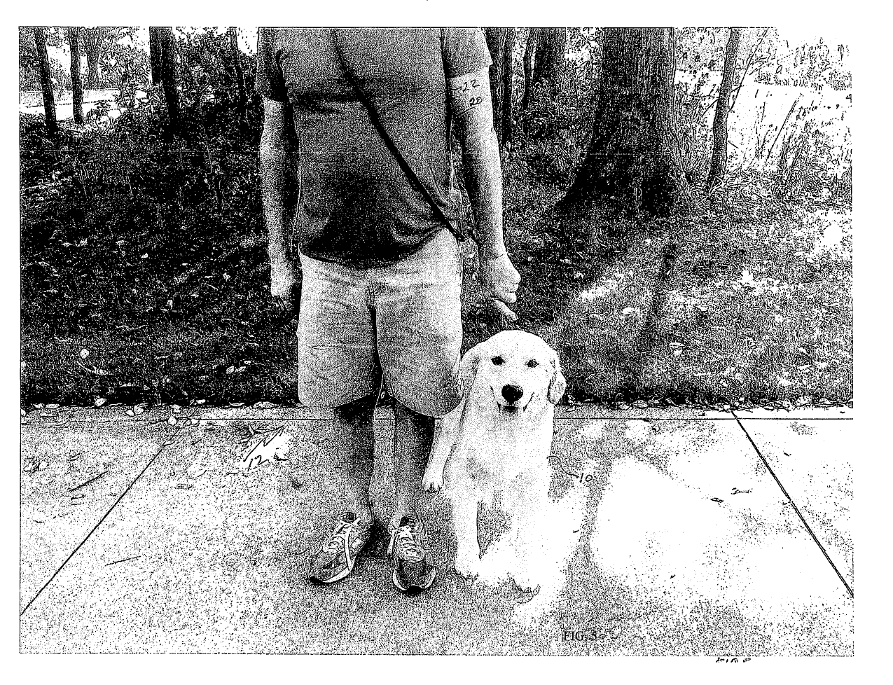

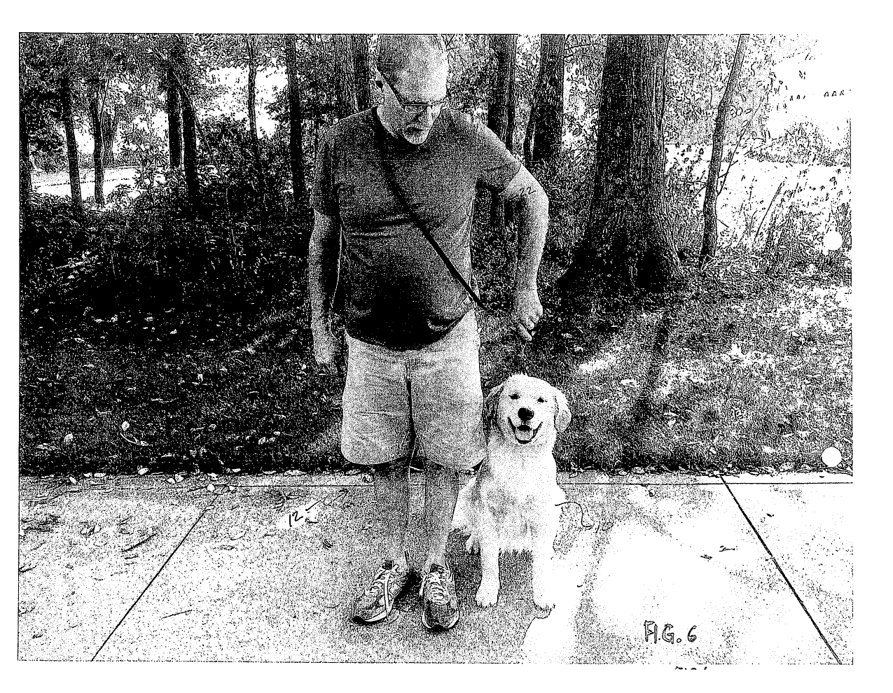

In conjunction with walking the dog, another important behavior is the dog willingly sitting next to its master (heel position) when the walking stops. Stopping with the dog at the master's side needs to be one of smooth transition. While the trainer walks at his normal pace, he must reach down and grasp the leash 20 with his/her hand next to the dog as close to the collar as possible without bending over. During the last step-and-a-half of the walk, as the trainer transitions into a stop, the trainer rotates his wrist and thumb so that the trainer's thumb is adjacent his thigh (FIG. 5), commanding the dog to “sit,” while at the same time raising his leash hand (FIG. 6). At this time, the hand and elbow are substantially in line with the trainer's hip and directly above the dog's collar, as shown in FIG. 6.

The “sit” command is stated only initially. The trainer then keeps steady, constant upward force on the collar from the leash. It may take several seconds for the dog to respond to the “sit” command, but it is important for the trainer to wait out any apparent stalemate without repeating the “sit” command again or changing the pressure on the leash. The trainer maintains the steady force until the instant it is noticed that the dog begins to relax into a sit. At that instant, the trainer immediately releases the leash without further inducement to allow the dog to complete the sit on his/her own and quietly praises the dog for the willingness exhibited and immediately releases his hand from the leash. Good timing from the trainer will take some practice and a few iterations, but the sequence of the procedure is important.

When the dog has sat, the trainer continues the quiet praise, touching the dog in a congratulatory manner. If the dog moves out of the sit position, the leash must again be raised back up without saying a word, holding the leash as long as necessary and repeating the steps above as soon as the dog begins to acquiesce and releasing the leash and resuming the praising again.

The dog may be rewarded with treats. If the trainer so desires, the treat reward should be given only when the dog is in the sitting position, after the dog has been touched and praised. The food treat is best given in an area between the dog's eyes and the trainer's eyes and at a point where the dog must slightly reach up for the treat, but not so much as to break the sit.

Thus far, attention has been given to the technique and methodology of a trainer in achieving behavioral conformity with the dog. Ultimately, however, it is the owner who needs to work with the dog and, to that end, the trainer needs to coach or train the owner. Of primary importance is teaching the owner about the issues of relaxing, handling technique, encouraging the owner to reinforce desired behaviors, and moving and presenting himself/herself confidently. In general, it is the duty of the trainer to help the owner impart a desired “energy” to his dog. For most owners, this is a unique feeling, for it is typically the first time, for instance, that they have led their dog with a hands-free leash. Experience has shown that owners are quite surprised upon realizing the uniqueness of walking their dogs on a hands-free leash, imparting to owners confidence in extending and developing their relationship with their dogs.

A primary area for coaching an owner is to teach the owner to relax when walking the dog, walking in a natural movement, not tentatively or with an arm bent as if still holding a leash. To that end, a trainer encourages the owner to walk a little faster than a normal pace, relax his arms and swing them loosely at his sides, allow his shoulders to relax, keep eyes forward, chin up and not twist his head so as to change the point of reference for the dog.

The owner is also taught to confidently take charge and shape the relationship, exuding a relaxed confidence with the dog, acting as the dog's leader.

Of paramount importance is the fact that the dog's owner must be vocal with the dog, praising the dog audibly. When walking the dog with a hands-free, over-the-shoulder leash, the owner must be encouraged to positively communicate with the dog, offering words of praise during those periods in which the presence of the dog on the leash is substantially undetectable, indicating that the dog is within the “sweet zone.” In effect, when there is no tension on the leash, the owner should be praising the dog, and when there is tension, the owner should be silent.

In a sterile environment, the methodologies just discussed, particularly with regard to walking the dog, are easy to attain. However, when walking a dog, various distractions arise, such as other animals, persons, or vehicles. The owner needs to be attentive to the environment, and particularly to that which is soon to be encountered, and reinforce the acceptable behavior of the dog as these distractions become more apparent so that the dog remains fixed upon its engagement with good behavior, rather than giving way to the distraction.

A final step in the basic training process of the dog is to engage behavioral training within the owner's home with the dog on his leash and collar while the owner is doing everyday housework such as making dinner, doing laundry, cleaning the house, and the like. These training sessions not only aid in developing the responsiveness of the dog to the owner's commands and wishes, but also serve to develop a close interpersonal relationship between the dog and the owner.

While one engages in normal daily activities, frequent turns, stops, stairs, and short walking distances are undertaken. Such activities provide an environment for compliance training since the owner typically has a set number of tasks to do and a fixed time frame in which to do them. It forces the “leader” quality in the owner.

As a general rule, when undertaking this step of training with the dog on its collar and over-the-shoulder leash, it is important for the owner to stay focused on the task that is being undertaken at any point in time. The owner must move at the regular pace necessary for the task and appropriate time management. When the owner turns around, he/she should be conscious of doing both right and left turns, even if the propensity of the owner is to routinely turn in one direction or the other when direction is not important. The obedience of the dog in making turns or accommodating turns of the owner in a home environment require coordination between the dog and the owner. For example, with the dog on the left side of the owner and the over-the-shoulder leash resting on the owner's right shoulder and draping across his torso and back to his left side, turns to the right are quite simple and basic as walking the dog outside. In a more restricted home environment, it may be necessary when turning to the left to command the dog “back” to give the dog fair warning that the owner is coming through. This allows clearance for the owner in making the left-hand turn in front of the dog. The instant the dog shows a willingness to the owner's movement, the dog needs to be praised.

Generally, when undertaking short work-training sessions with dogs in a home, the owner should not require that the dog sit at every stop. It should be sufficient for the dog to honor the owner to stay close without the need for any tension on the leash.

If it is desired that the dog sit, it can be so commanded. If the dog sits on its own, intermittent praise and petting will reward it for its willingness.

In general, once owners have mastered the first three steps of the training as presented above, undertaking the short compliance-training exercises within the home during daily work will readily take on a format with which both the owner and the dog feel comfortable. The owner feels comfortable because he is engaging his daily routine, and the dog because the routine will rapidly gain the degree of familiarity that allows both the owner and the dog to work in unison.

The foregoing dog-training process provides a refreshing approach to training a dog to walk willingly with the handler as a team. The methodology is simple, relaxed, and hands-free. It has been found that in as little as a few hours, most trainers and owners are able to confidently transition the dog's heeling behavior from pulling to pleasing. The act of the dog walking attentively and willingly with its owner as a team is a strong statement of the relationship that exists between the two. Over a course of employing this methodology, it has been observed that within a matter of couple of days, the behavior and obedience of dogs subjected to the methodology have improved remarkably. The dogs walking with their owners, even up and down stairs, and participating in their owners' daily routines have become one of companionship and unison, rather than conflict and disappointment.

Thus, it can be seen that the various aspects of the invention have been attained by the process presented and described above. While in accordance with the patent statutes, only the best known and preferred embodiments of the invention has been presented and described in detail, the invention is not limited thereto or thereby. Accordingly, for an appreciation of the true scope and breadth of the invention, reference should be made to the following claims.

What is claimed is:

1. A method for training a dog, comprising:
developing distance attention in the dog with a long-line leash, effecting a return of the dog to a trainer upon the trainer issuing a command to “come;”
developing restraint in the dog in effectively negotiating stairs without forging ahead of the trainer;
developing discipline in the dog to walk alongside the trainer on an over-the-shoulder leash and within a zone established by the leash; and
undertaking behavioral training of the dog with leash and collar constraint within a home environment and during daily routines.

2. The method according to claim 1, wherein the step of developing distance attenuation in the dog comprises the trainer holding the long-line leash loosely, allowing the dog to wander away by natural distraction, issuing the audible command “come,” and immediately applying sufficient pulling force on the leash to turn the dog.

3. The method according to claim 2, further comprising offering verbal praise and encouragement to the dog as soon as the dog makes eye contact with the trainer or takes a first step toward the trainer.

4. The method according to claim 3, further comprising the offering by the trainer of verbal praise and encouragement along with the “come” command as long as the dog is moving toward the trainer.

5. The method according to claim 4, further comprising the step of the trainer immediately going silent should the dog break eye contact with the trainer or veer off course.

6. The method according to claim 5, wherein verbal praising and encouragement are renewed immediately upon eye contact or movement on course renews.

7. The method according to claim 6, wherein said step of developing distance attenuation is practiced in a sequence of 5-6 repetitions.

8. The method according to claim 1, wherein the step of developing restraint in the dog in effectively negotiating stairs comprises the trainer securing the dog's collar to a long leash, with the dog on one side of the trainer and the trainer holding a portion of the long leash in the hand of the trainer's opposite side, the length of the leash from the trainer's hand to the collar being such that, when walking, the leash crosses the trainer's thigh on the side adjacent the dog, the thigh applying force to the collar when the trainer begins to walk and the dog remains stationary.

9. The method according to claim 8, further comprising the dog and trainer walking toward a set of steps, the trainer paying out a limited amount of leash should the dog forge toward or up the steps, following by an abrupt termination of the payout.

10. The method according to claim 9, further comprising the trainer backing down the steps immediately following said abrupt termination until the dog either makes eye contact with the trainer or begins to come toward the trainer, at which time the trainer praises the dog.

11. The method according to claim 10, wherein the trainer makes quick leash checks if the trainer notices that the dog is focusing on the step in front of the trainer, urging the dog to the step upon which the trainer is standing, followed by praise from the trainer for such behavior.

12. The method according to claim 1, wherein the step of developing discipline in the dog to walk alongside the trainer comprises placing the over-the-shoulder leash with a loop crossing resting on a shoulder of the trainer on a side opposite the dog and encircling the trainer's torso.

13. The method according to claim 12, wherein the trainer walks, hands free, feeling the presence of the dog ahead or behind the trainer through force imparted through the leash to the trainer's torso, the absence of such force indicating that the dog is alongside the trainer, at which time the dog is praised.

14. The method according to claim 13, wherein the trainer speeds up the walking pace when feeling chest pressure from the leash to urge the dog forward, and grasps the leash and checks it when feeling back pressure from the leash when the dog is ahead of the trainer.

15. The method according to claim 14, further comprising the trainer grasping the leash near the collar, coming to stop in walking, issuing the command “sit” while raising the leash hand to impart upward force on the collar until the dog relaxes into a sit, at which time the dog is praised.

16. The method according to claim 1, wherein the step of behavioral training of the dog within a home environment comprises placement of the dog on an over-the-shoulder leash and movement of trainer and dog together as the trainer engages household tasks.

17. The method according to claim 16, wherein additional commands such as “back” are used to accommodate turns in tight quarters and wherein the “sit” command is used infrequently to accommodate movements of short distances.
